(19) United States
(12) Patent Application Publication
(10) Pub. No.: US 2012/0125207 A1
(43) Pub. Date: May 24, 2012

(54) AUTOMATIC BREAD MAKING MACHINE

(76) Inventors: Teruaki Taguchi, Tottori-shi (JP); Takashi Watanabe, Tottori-shi (JP); Yasuyuki Ito, Tottori-shi (JP); Kazuya Yano, Tottori-shi (JP)

(21) Appl. No.: 13/388,572

(22) PCT Filed: Aug. 24, 2010
(86) PCT No.: PCT/JP2010/064221

§ 371 Date: Feb. 2, 2012

(30) Foreign Application Priority Data
Aug. 25, 2008 (JP) 2009 194126
Aug. 25, 2009 (JP) 2009 194121

(51) Int. Cl. A47J 37/00

(52) U.S. Cl. 99/348

(57) ABSTRACT

Disclosed is an automatic bread making machine (1) equipped with a bread container (50) into which bread making materials are placed, a baking chamber (40) that is disposed within a main body (10) and that receives the bread container (50), a blade rotation shaft (52) that is disposed on the bottom of the bread container (50), a grinding blade (54) and a mixing blade (72) that are disposed so as to be rotatable by the rotation of the blade rotation shaft (52), and a motor (60) that is disposed within the body (10) and that provides rotating power to the blade rotation shaft (52). Grinding is performed with the grinding blade (54) when the blade rotation shaft (52) is rotated in one direction, and mixing is performed with the mixing blade (72) when the blade rotation shaft (52) is rotated in the opposite direction to the aforementioned direction.

### TECHNICAL FIELD

The present invention is related to an automatic bread making machine for use mainly in general households.

### BACKGROUND ART

Commercially available bread making machines for household use are typically configured such that a bread container in which bread ingredients are placed is put in a baking chamber, the bread ingredients inside the bread container being mixed and kneaded by using a mixing/kneading blade, and after a fermentation process, baked into bread, by using the bread container as a baking pan. An example of such bread making machines is disclosed in Patent Literature 1.

Sometimes, optional ingredients such as raisins and nuts are added to the bread ingredients to bake bread with an optional ingredient. Patent Literature 2 discloses an automatic bread making machine equipped with means for automatically feeding sub bread ingredients such as raisins, nuts, or cheese.

### CITATION LIST

### Patent Literature

Patent Literature 1: JP-A-2000-116526
Patent Literature 2: Japan Patent No. 3191645

### SUMMARY OF INVENTION

### Technical Problem

Conventionally, bread making needs to be started by preparing flour made by grinding grains of cereal such as wheat or rice, or ready-mixed flour made of such flour and various auxiliary ingredients mixed together. Even when there are cereal grains (typically rice) available at hand, it is not easy to make bread directly from such cereal grains.

The present invention has been made in view of the above problems, and an object of the present invention is to provide an automatic bread making machine equipped with a mechanism that is convenient for making bread directly from cereal grains, and to make bread making easier to work on.

### Solution to Problem

To achieve the above object, according to the present invention, an automatic bread making machine includes: a bread container in which a bread ingredient is put; a baking chamber which is provided inside a body and accommodates the bread container; a blade rotation shaft which is provided at a bottom portion of the bread container; a grinding blade and a mixing/kneading blade which are rotatable by rotation of the blade rotation shaft; and a motor which is provided inside the body and imparts a rotational force to the blade rotation shaft. Here, a grinding function is exerted by using the grinding blade when the blade rotation shaft rotates in one direction, while a kneading function is exerted by using the mixing/kneading blade when the blade rotation shaft rotates in a direction opposite to said one direction.

With this structure, a bread ingredient can be produced inside the bread container by putting cereal grains in the bread container and grinding them with the grinding blade. Thereafter, mixing/kneading of bread ingredients is carried out by the mixing/kneading blade, and the procedure can further proceed in the bread container to fermentation and baking processes. Cereal grains ground inside the bread container can be baked into bread in the same bread container. Thus, in contrast to a structure in which cereal grains are first ground in a container and then shifted to the bread container, this structure is free from volume loss of cereal grains resulting from some of the cereal grains being left in the container without moving to the bread container. Furthermore, the grinding blade and the mixing/kneading blade can remain inside the bread container from the start of the grinding of cereal grains until the end of baking operation, and moreover, switching between the grinding blade and the mixing/kneading blade can be done simply by changing the rotation direction of the blade rotation shaft, which makes the machine easy to handle.

Preferably, in the automatic bread making machine structured as described above, the grinding blade is unrotatably attached to the blade rotation shaft, the mixing/kneading blade is provided on an external surface of a dome-shaped cover which is attached to the blade rotation shaft so as to cover the grinding blade, and a rotational force of the blade rotation shaft is not transmitted to the cover when the blade rotation shaft rotates in said one direction, while the cover rotates together with the blade rotation shaft when the blade rotation shaft rotates in the direction opposite to said one direction.

With this structure, since cereal grains are ground inside the cover, they do not scatter about outside the bread container during the grinding process.

In the automatic bread making machine structured as described above, the mixing/kneading blade may be bonded to the external surface of the cover.

With this structure, it is possible to achieve a simple-structured, robust combination of the cover and the mixing/kneading blade.

In the automatic bread making machine structured as described above, a clutch may be provided between the blade rotation shaft and the cover such that the clutch uncouples the blade rotation shaft and the cover from each other when the blade shaft rotates in said one direction, while the clutch couples the blade rotation shaft and the cover to each other when the blade rotation shaft rotates in the direction opposite to said one direction. Furthermore, in this structure, the mixing/kneading blade may be attached to the cover such that a posture of the mixing/kneading blade is changeable, and the clutch may switch a state of coupling between the blade rotation shaft and the cover according to the posture of the mixing/kneading blade.

In the automatic bread making machine structured as described above, the cover may have formed therein at least one window through which a space inside the cover and a space outside the cover communicate with each other, and an internal surface of the cover may have formed thereon at least one rib which guides a ground substance produced by the grinding blade toward the window.

With this structure, the rib is able to perform a function of promoting the grinding of the cereal grains by reducing flow of a mixture of the cereal grains and the liquid inside the cover. Furthermore, the mixture of the ground cereal grains and the liquid is guided by the rib toward the window, to be discharged out of the cover through the window, and thus the ground cereal grains do not stay inside the cover, which contributes to even higher efficiency of grinding cereal grains. The rib also helps to quickly discharge dough material out of the cover in mixing/kneading. Incidentally, with a structure in which a plurality of windows and ribs are provided as the window and the rib, respectively, it is possible to more smoothly discharge the mixture of the ground cereal grains and the liquid or the dough material present inside the cover out of the cover through the windows.

In the automatic bread making machine structured as described above, it is preferable that the window be located at a same height as, or higher than, the grinding blade.

With this structure, the mixture of the ground cereal grains and the liquid is discharged out of the cover in a horizontal or obliquely upward direction, and this helps promote the circulation of the cereal grains.

In the automatic bread making machine structured as described above, preferably, the rib extends obliquely with respect to a radius direction of the cover from near a center of the cover to a circumferential annular wall of the cover, the rib being curved such that a side thereof which faces bread ingredients when the bread ingredients rush thereto is convex.

With this structure, the rib changes the flow of the mixture of the cereal grains and the liquid, to increase the chance for the mixture to strike the grinding blade, which contributes to efficient grinding of the cereal grains. Also, since the rib is curved such that a side thereof which faces bread ingredients when the bread ingredients rush thereto is convex, the mixture of the cereal grain and the liquid is less likely to stay on a surface of the rib and more likely to smoothly flow toward the window.

### Advantageous Effects of Invention

According to the present invention, it is possible to bake bread by using cereal grains at hand, and thus there is no need of taking the trouble to go and buy cereal flour. In the case of rice, bread can be baked by using rice grains of any polishing rate from brown to white. And, since the processes from the grinding of cereal grains to the baking of bread can be all carried out in the bread container placed inside the baking chamber, there is less possibility of foreign matter mixing in bread dough. Furthermore, in contrast to a structure in which cereal grains are first ground in a container and then shifted into the bread container, this structure is free from loss associated with the shifting, in which some of the cereal grains may stick to the container to be left therein. Since the grinding blade and the mixing/kneading blade are placed inside the bread container from beginning to end, it is easy to handle them, and also, cereal grains can be ground without scattering out of the bread container. And, since the window is formed in the cover through which the space inside the cover and the space outside the cover communicate with each other, and the rib is formed on the internal surface of the cover to guide the ground substance produced by the grinding blade toward the window, the ground cereal grains can be quickly discharged out of the cover, and this makes it possible to grind the cereal grains efficiently. The rib promotes the grinding of the cereal grains by reducing flow of a mixture of the cereal grains and the liquid, and thus, according to the present invention, the grinding of cereal grains can be carried out with further enhance efficiency.

### BRIEF DESCRIPTION OF DRAWINGS

FIG. 1A vertical sectional view showing an automatic bread making machine of a first embodiment of the present invention;

FIG. 2 A vertical sectional view showing the automatic bread making machine of the first embodiment taken along a direction perpendicular to the sectional direction of FIG. 1;

FIG. 3 A top plan view showing the automatic bread making machine of the first embodiment;

FIG. 4 A vertical sectional view similar to FIG. 1 showing the automatic bread making machine of the first embodiment in a grinding process;

FIG. 5 A vertical sectional view similar to FIG. 2 showing the automatic bread making machine of the first embodiment in the grinding process;

FIG. 6 A control block diagram of the automatic bread making machine of the first embodiment;

FIG. 7 An overall flow chart showing a first example of bread making process;

FIG. 8 A flow chart showing a pre-grinding soaking process in the first example of bread making process;

FIG. 9 A flow chart showing a grinding process in the first example of bread making process;

FIG. 10 A flow chart showing a mixing/kneading process in the first example of bread making process;

FIG. 11A flow chart showing a fermentation process in the first example of bread making process;

FIG. 12 A flow chart showing a baking process in the first example of bread making process;

FIG. 13 An overall flow chart showing a second example of bread making process;

FIG. 14 A flow chart showing a post-grinding soaking process in the second example of bread-making process;

FIG. 15 An overall flow chart showing a third example of bread making process;

FIG. 16 A vertical sectional view showing an automatic bread making machine of a second embodiment of the present invention;

FIG. 17 A vertical sectional view showing the automatic bread making machine of the second embodiment taken along a direction perpendicular to the sectional direction of FIG. 16;

FIG. 18 A top plan view showing a bread container of the automatic bread making machine of the second embodiment in the mixing/kneading process;

FIG. 19 A top plan view showing the bread container of the automatic bread making machine of the second embodiment in the grinding process;

FIG. 20 A perspective view showing a cover which is provided in the automatic bread making machine of the second embodiment and to which a mixing/kneading blade is attached;

FIG. 21A side view showing the cover which is provided in the automatic bread making machine of the second embodiment and to which the mixing/kneading blade is attached;

FIG. 22 A perspective view as seen from below showing the cover which is provided in the automatic bread making machine of the second embodiment and to which the mixing/kneading blade is attached;

FIG. 23 A bottom plan view showing the cover which is provided in the automatic bread making machine of the second embodiment and to which the mixing/kneading blade is attached;

FIG. 24 A bottom plan view showing the cover in the automatic bread making machine of the second embodiment when the mixing/kneading blade is in an open posture; and

FIG. 25 A control block diagram of the automatic bread making machine of the second embodiment.

### DESCRIPTION OF EMBODIMENTS

Hereinafter, first and second embodiments of an automatic bread making machine of the present invention will be described with reference to the drawings.

### First Embodiment

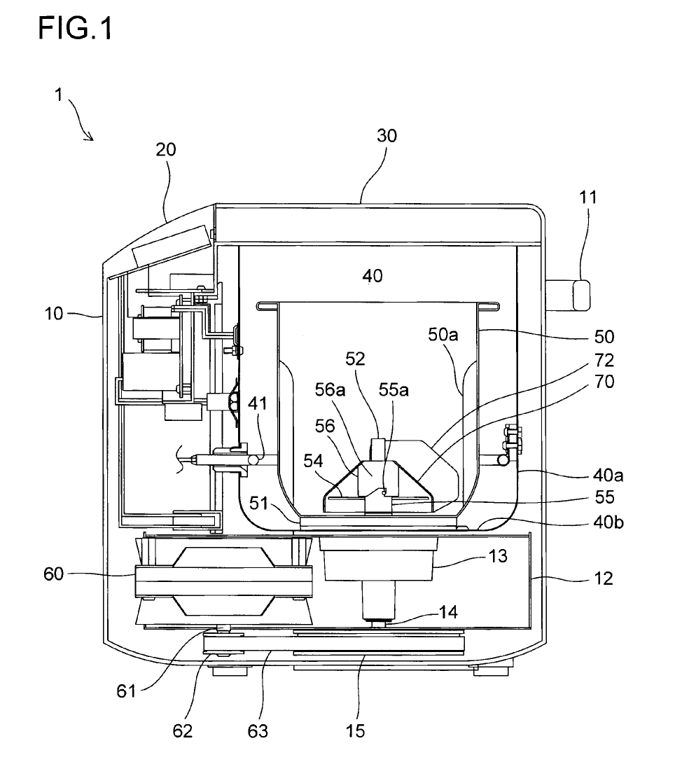

First, the structure of an automatic bread making machine of the first embodiment will be described with reference to FIGS. 1 to 5. In FIG. 1, the left side is the front (façade) side of the automatic bread making machine 1, and the right side is the rear (back) side of the same. The left-hand side and the right-hand side of an observer facing the front of the automatic bread making machine 1 are the left side and the right side, respectively, of the automatic bread making machine 1.

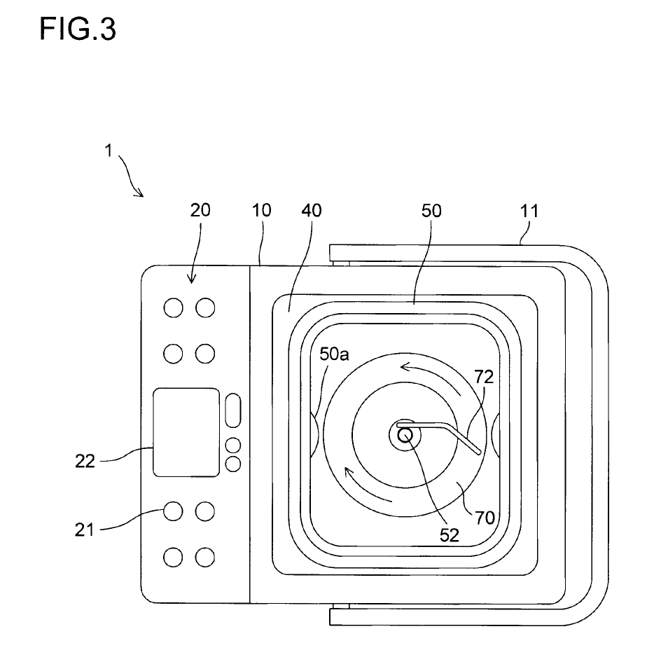

The automatic bread making machine 1 has a box-shaped body 10 formed with an external shell made of a synthetic resin. To an upper portion of the body 10, a handle 11 for carrying is attached. An operation portion 20 is provided in a front portion of an upper surface of the body 10. The operation portion 20 is, as shown in FIG. 3, provided with: a group of operation keys 21 including keys such as a key for selecting bread type (wheat bread, rice powder bread, bread with an optional ingredient), a cooking program selection key, a timer key, a start key, and a cancellation key; and a display portion 22 that displays a description of a set cooking program and time set through the timer key. The display portion 22 is formed with, for example, a liquid crystal display panel.

A portion of the upper surface of the body behind the operation portion 20 is covered with a lid 30 made of a synthetic resin. The lid 30 is hinged to a rear edge of the body 10 with an unillustrated hinge shaft, to be swingable around the hinge shaft within a vertical plane.

Inside the body 10, a baking chamber 40 is provided. The baking chamber 40 is made of a sheet metal and has an open top through which a bread container 50 is put thereinto. The baking chamber 40 has a peripheral side wall 40a which is rectangular in horizontal section and a bottom wall 40b.

Inside the body 10, a base 12 made of a sheet metal is placed. On the base 12, there is fixed a bread container support portion 13, which is made by die casting an aluminum alloy, at a position corresponding to a position in the center of the baking chamber 40. The inside of the bread container support portion 13 is exposed to the inside of the baking chamber 40.

At a position in the center of the bread container support portion 13, a drive shaft 14 is vertically supported. To a lower end of the drive shaft 14, a pulley 15 is fixed. The pulley 15 is made to rotate by a motor 60 supported by the base 12. The motor 60 has a vertical shaft, and has an output shaft 61 protruding from a lower surface thereof. To the output shaft 61, there is fixed a pulley 62, which is coupled to the pulley 15 via a belt 63. The bread container support portion 13 receives a cylindrical pedestal 51 which is fixed to a bottom surface of the bread container 50, and thereby supports the bread container 50. The pedestal 51 is also made by die casting an aluminum alloy.

The bread container 50 is made of a metal sheet in a bucket-like shape and provided with a carrying handle (not shown) attached to a rim of an opening thereof. The bread container 50 is rectangular with rounded corners in horizontal section, having a ridge-shaped protrusion 50a, which extends in a vertical direction, formed on an internal surface of each of two opposing sides of the four sides thereof.

At a position in the center of a bottom portion of the bread container 50, a vertical blade rotation shaft 52 is vertically supported, with sealing applied thereto. To the blade rotation shaft 52, a rotational force is transmitted from the drive shaft 14 via a coupling 53. The coupling 53 is formed of two members, one of which is fixed to a lower end of the blade rotation shaft 52 and the other of which is fixed to an upper end of the drive shaft 14. The entirety of the coupling 53 is enclosed by the pedestal 51 and the bread container support portion 13.

Unillustrated protrusions are formed on an internal peripheral surface of the bread container support portion 13 and on an outer peripheral surface of the pedestal 51. These protrusions form a known bayonet coupling. Specifically, in attaching the bread container 50 to the bread container support portion 13, the bread container 50 is brought down such that the protrusions of the pedestal 51 do not interfere with the protrusions of the bread container support portion 13. Then, after the pedestal 51 is fitted into the bread container support portion 13, the bread container 50 is horizontally turned, so that the protrusions of the pedestal 51 are engaged with lower surfaces of the protrusions of the bread container support portion 13, as a result of which the bread container 50 is fixed such that it cannot be pulled out upward. This operation also accomplishes coupling of the coupling 53. The bread container 50 is twisted, when being set, in the same direction as the rotation direction of a mixing/kneading blade which will be described later, so that rotation of the mixing/kneading blade does not cause the bread container 50 to come off.

A heating device 41 placed inside the baking chamber 40 surrounds the bread container 50 and applies heat to bread ingredients. The heating device 41 is formed with a sheath heater.

The blade rotation shaft 52 has a grinding blade 54 unrotatably attached thereto at a position thereof above the bottom portion of the bread container 50. The grinding blade 54 is made of stainless steel and shaped like a propeller of an airplane.

The grinding blade 54 is fixed to a coupling member 55 having a unidirectional engagement portion 55a at an upper surface thereof. In a lower surface of the coupling member 55, there is formed a groove (not shown) thereacross in a direction of the diameter thereof. An unillustrated pin horizontally penetrating the blade rotation shaft 52 receives the coupling member 55 and engages with the groove to unrotatably couple the coupling member 55 to the blade rotation shaft 52. The combination of the grinding blade 54 and the coupling member 55 is able to be easily pulled out of the blade rotation shaft 52, and this facilitates cleaning after a bread making operation and replacement of a dull grinding blade 54 with a new one.

To an upper end of the blade rotation shaft 52, a dome-shaped cover 70 which is circular in plan view is attached. The cover 70 is, for example, formed by pressing a stainless steel sheet into a shape such that a cylindrical portion is connected to a lower end of a circular truncated cone, and covers up the grinding blade 54. To an external surface of the cover 70, a mixing/kneading blade 72 having a “<” shape in plan view is bonded by, for example, welding.

The cover 70 is fixed to a coupling member 56 paired with the coupling member 55. The coupling member 56 is rotatably fitted to the blade rotation shaft 52, and received by the coupling member 55. The coupling member 56 has, in a lower surface thereof, a unidirectional engagement portion 56a that engages with the unidirectional engagement portion 55a of the coupling member 55. The combination of the cover 70, the mixing/kneading blade 72, and the coupling member 56 is also able to be easily pulled out of the blade rotation shaft 52, and this facilitates cleaning after a bread making operation.

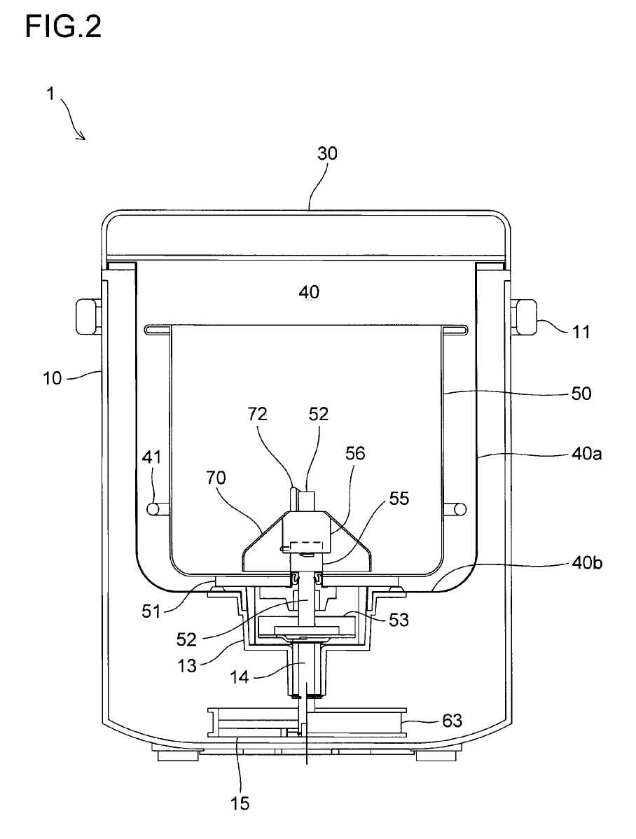

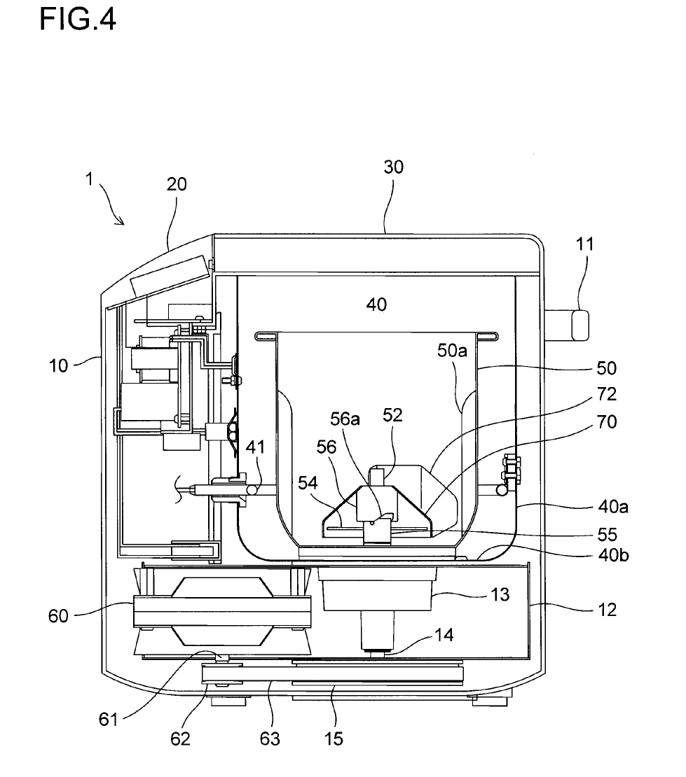

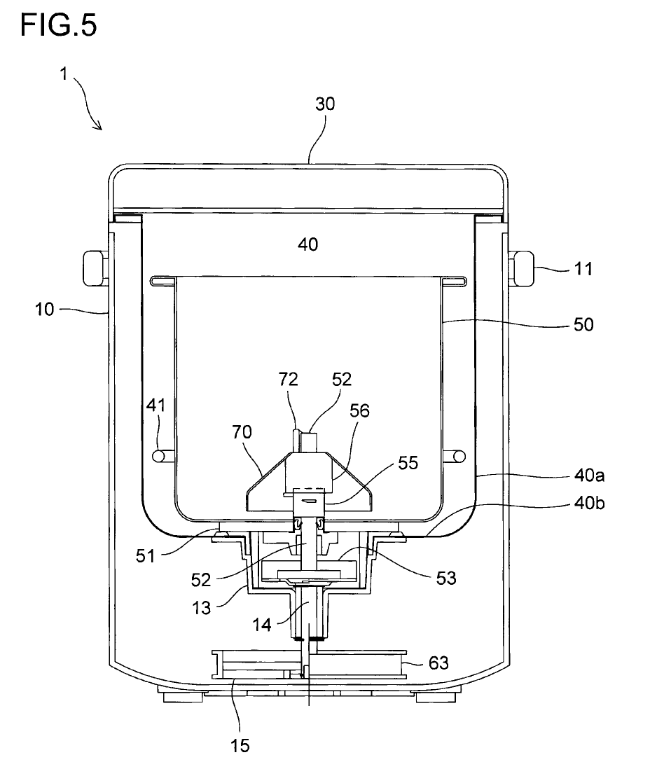

When the blade rotation shaft 52 rotates counterclockwise in FIG. 3, the unidirectional engagement portions 55a and 56a engage with each other (the state shown in FIGS. 1 and 2), and the cover 70 and the mixing/kneading blade 72 together rotate counterclockwise integrally with the blade rotation shaft 52. When the blade rotation shaft 52 rotates clockwise in FIG. 3, the unidirectional engagement portions 55a and 56a disengage from each other (the state shown in FIGS. 4 and 5), and the cover 70 and the mixing/kneading blade 72 stop rotating. The grinding blade 54 rotates with the blade rotation shaft 54 in whichever direction.

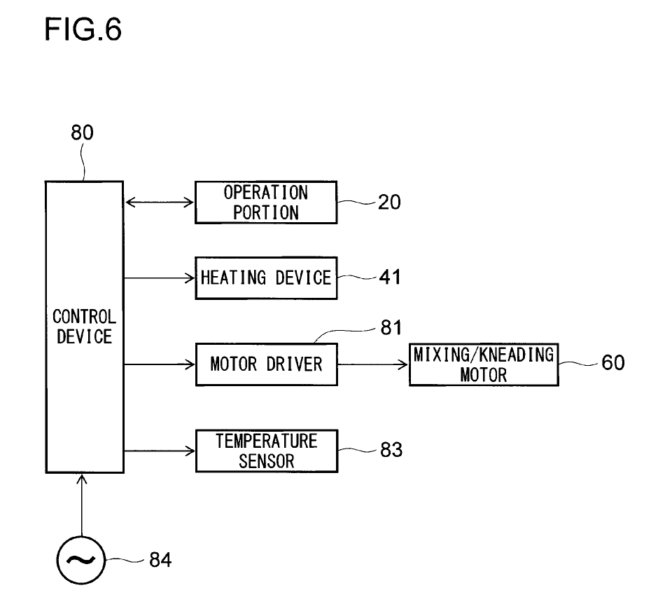

Operation of the automatic bread making machine 1 is controlled by a control device 80 shown in FIG. 6. The control device 80 is formed of a circuit board appropriately located within the body 10 (preferably at a place where it is least affected by heat from the baking chamber 40). To the control device 80, the operation portion 20 and the heating device 41 are connected, and further, a motor driver 81 of the motor 60 and a temperature sensor 83 are also connected to the control device 80. The temperature sensor 83 is disposed inside the baking chamber 40, and detects temperature of the baking chamber 40. Reference numeral 84 denotes a commercial power supply that supplies power to each component.

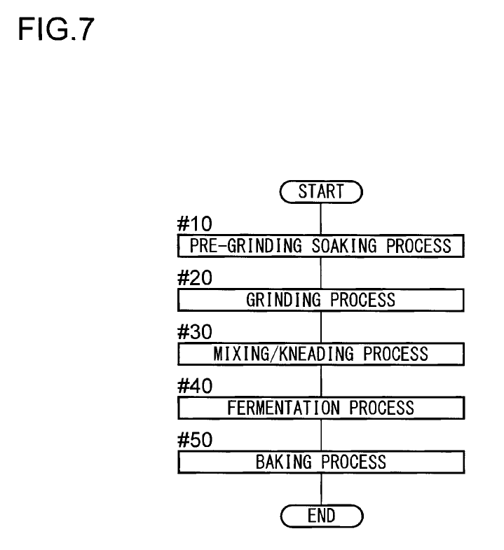

Next, a description will be given of a process of making bread from cereal grains by using the automatic bread making machine 1, with reference to FIGS. 7 to 15. Among the figures, FIGS. 7 to 12 show a first example of bread making process.

FIG. 7 is an overall flow chart showing the first example of bread making process. As shown in FIG. 7, in the first example of bread making process, a pre-grinding soaking process #10, a grinding process #20, a mixing/kneading process #30, a fermentation process #40, and a baking process #50 are carried out in this order. Next, the processes will be described one by one.

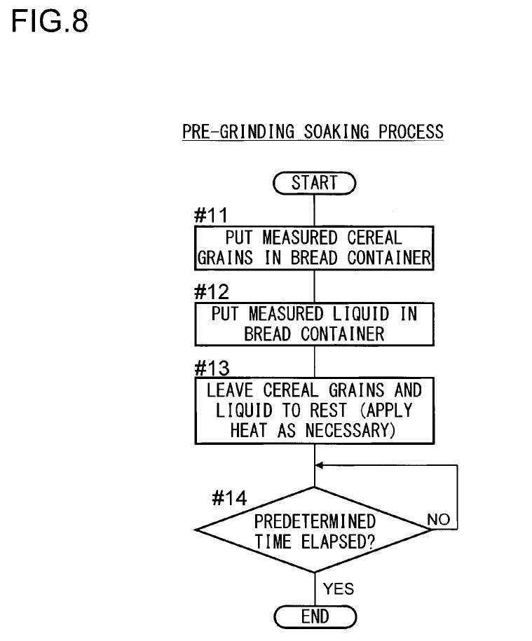

In the pre-grinding soaking process #10 shown in FIG. 8, first, in step #11, a user measures cereal grains and puts a certain amount of cereal grains in the bread container 50. As the cereal grains, rice is the most available, but grains of other cereals such as wheat, barley, foxtail millet, Japanese barnyard millet, buckwheat (soba), and corn may be used.

In step #12, the user measures liquid and puts a certain amount of liquid in the bread container 50. The liquid is typically water, but a soup stock which contains a taste component may be used instead, or fruit juice may be used alternatively. The liquid may contain alcohol. Step #11 and step #12 may be performed in a reverse order.

The cereal grains and the liquid may be put into the bread container 50 with the bread container 50 placed either outside or inside the baking chamber 40.

After the cereal grains and the liquid are put into the bread container 50 placed inside the baking chamber 40, or after the bread container 50 in which the cereal grains and the liquid are put outside the baking chamber 40 is attached to the bread container support portion 13, the lid 30 is closed. Here, the user presses a predetermined operation key of the operation portion 20 to start counting how long the cereal grains are soaked in the liquid. At this time point, step #13 starts.

In step #13, a mixture of the cereal grains and the liquid is left to rest in the bread container 50, so that the liquid soaks into the cereal grains. Generally, the higher the liquid temperature is, the faster the cereal grains absorb the liquid, and thus the heating device 41 may be energized to raise the temperature of the baking chamber 40.

In step #14, the control device 80 checks how long the cereal grains and the liquid have been left to rest. The pre-grinding soaking process #10 finishes when the cereal grains and the liquid are found to have been left to rest for a predetermined time. This is informed to the user via a display provided in the operation portion 20, via sound, etc.

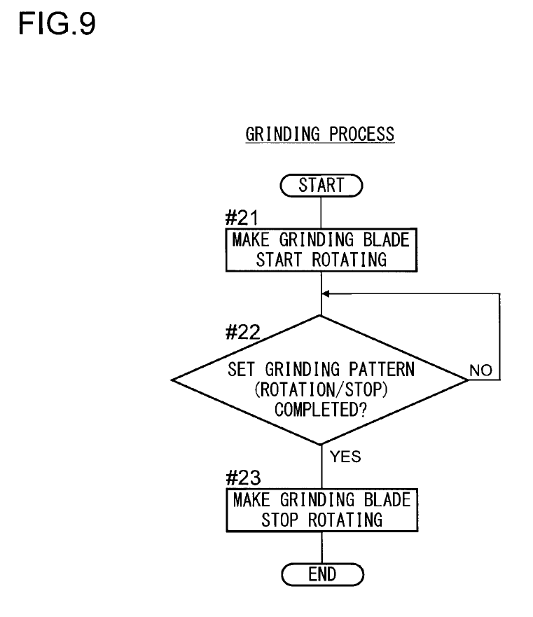

Following the pre-grinding soaking process #10, the grinding process #20 shown in FIG. 9 is carried out. When the user inputs grinding operation data (kind and amount of cereal grains, kind of bread to be baked, etc.) through the operation portion 20 and presses the start key, step #21 is started.

In step #21, the control device 80 drives the motor 60, to make the blade rotation shaft 52 rotate clockwise in FIG. 3. Then, the grinding blade 54 starts rotating in the mixture of the cereal grains and the liquid. When the blade rotation shaft 52 rotates in this direction, as shown in FIGS. 4 and 5, engagement between the coupling members 55 and 56 is released, and the cover 70 and the mixing/kneading blade 72 do not rotate. The grinding blade 54 alone rotates together with the blade rotation shaft 52, and exerts a grinding function. Since the cereal grains are ground by the grinding blade 54 after the liquid has soaked into them, it is easy to grind them to their cores. Since the grinding is performed inside the cover 70, the cereal grains are prevented from scattering around outside the bread container 50.

As a result of being disengaged from the coupling member 55, the coupling member 56 is lifted upward as shown in FIGS. 4 and 5, increasing a clearance between a lower rim of the cover 70 and the bottom surface of the bread container 50. When a mixture of the ground cereal grains and the liquid is discharged through this clearance, the mixture of the cereal grains and the liquid existing outside the cover 70 moves into the cover 70. In this way, the cereal grains are gradually ground to be fine.

In step #22, the control device 80 checks whether or not the grinding has been completed according to a set grinding pattern (whether the grinding blade is to be continuously rotated or intermittently rotated interspersed with stop periods, how the intervals should be set and how long a rotation time period should be in the case of intermittent rotation, etc.).

When the grinding of the set grinding pattern is found to have been completed, the procedure proceeds to step #23, where the grinding blade 54 finishes rotating, and the grinding process #20 is finished. This is informed to the user via a display provided on the display portion 22, via sound, etc.

In the above description, after the pre-grinding soaking process #10, the grinding process #20 is made to start by the user by operating the operation portion 20; however, the grinding process #20 may be set to automatically start after the pre-grinding soaking process #10 if the user inputs grinding operation data either before or in the course of the pre-grinding soaking process #10.

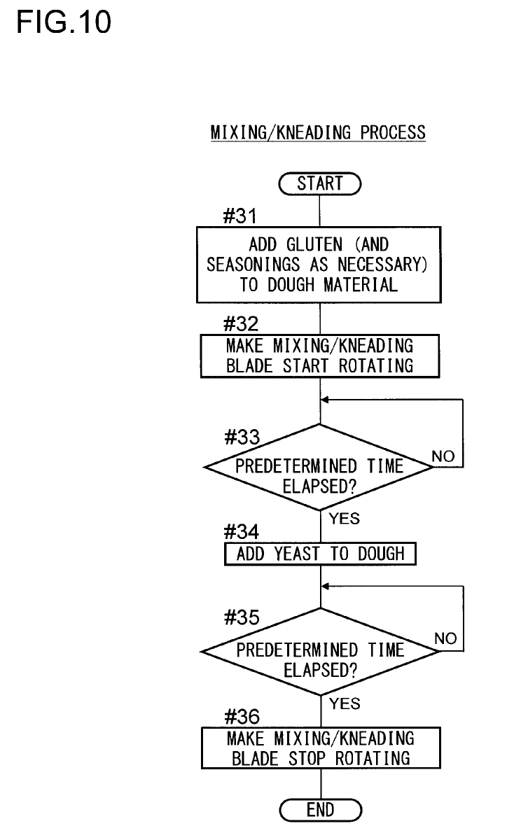

Following the grinding process #20, the procedure proceeds to the mixing/kneading process #30 shown in FIG. 10. At the start of the mixing/kneading process #30, the cereal grains and the liquid in the bread container 50 have become a dough material in a pasty or slurry state. Note that, herein, a substance that is present at the start of the mixing/kneading process #30 is referred to as “dough material,” while a substance becoming increasingly similar to the aimed dough as the mixing/kneading proceeds is referred to as “dough” even before it is completed as dough.

In step #31, the user opens the lid 30 to add a certain amount of gluten to the dough material. Any of seasonings such as salt, sugar, and shortening is added to the dough material as necessary. It is also possible to provide the automatic bread making machine 1 with an automatic feeder for gluten and seasonings to throw them in without bothering the user.

Substantially simultaneously with step #31, the user operates the operation portion 20 to input the kind of bread to be baked and the cooking program to be performed. When the machine is ready, the user presses the start key, to start the bread making operation in which processes are automatically performed in series from the mixing/kneading process #30, to the fermentation process #40, and to the baking process #50.

In step #32, the control device 80 drives the motor 60 to make the blade rotation shaft 52 rotate counterclockwise in FIG. 3. This time, the coupling members 55 and 56 engage with each other as shown in FIGS. 1 and 2, and the cover 70 and the mixing/kneading blade 72 together rotate integrally with the blade rotation shaft 52.

Here, the control device 80 energizes the heating device 41 to raise the temperature of the baking chamber 40. As the mixing/kneading blade 72 rotates, the dough material is mixed and kneaded, to be worked into a lump of dough having predetermined elasticity. The mixing/kneading blade 72 swings the dough around and beats it against an internal wall of the bread container 50, and this adds an element of “kneading (folding, pressing and stretching)” to the mixing/kneading process. The protrusions 50a formed on the internal wall of the bread container 50 helps the “kneading” to proceed.

In step #33, the control device 80 checks how much time has elapsed since the start of the rotation of the mixing/kneading blade 72. When a predetermined period of time is found to have elapsed, the procedure proceeds to step #34.

In step #34, the user opens the lid 30 to add yeast to the dough. The yeast added to the dough here is dry yeast. Instead of yeast, baking powder may be used. It is also possible to adopt an automatic feeder for yeast or baking powder as well, to thereby save the user time and trouble.

In step #35, the control device 80 checks how much time has elapsed since the addition of yeast to the dough. When a period of time necessary to obtain desired dough is found to have elapsed, the procedure proceeds to step #36, where the mixing/kneading blade 72 finishes rotating. At this time, a lump of dough having required elasticity is completed.

In the case of baking bread with an optional ingredient, at any step in the mixing/kneading process #30, the optional ingredient is added. An automatic feeder can be adopted for optional ingredients, as well.

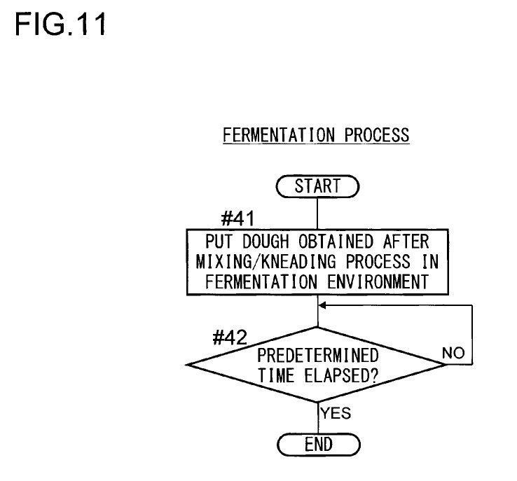

Following the mixing/kneading process #30, the fermentation process #40 shown in FIG. 11 is carried out. In step #41, dough resulting from the mixing/kneading process 30 is placed in a fermentation environment. That is, the control device 80 sets the temperature of the baking chamber 40 within a temperature range suitable for fermentation, by energizing the heating device 41, if necessary. The user forms the dough into a desired shape and leaves it to rest as necessary.

In step #42, the control device 80 checks how long the dough has been placed in the fermentation environment. When a predetermined time is found to have elapsed, the fermentation process #40 is finished.

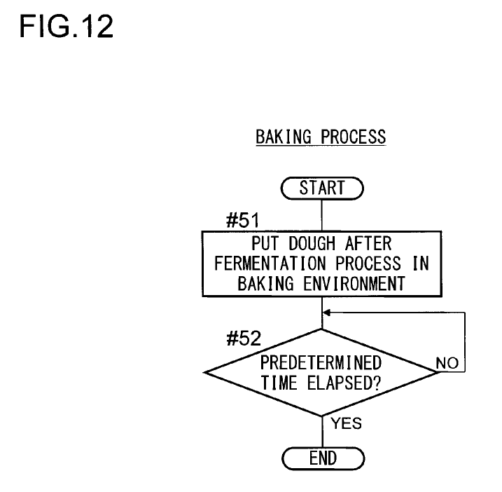

Following the fermentation process #40, the baking process #50 shown in FIG. 12 is carried out. In step #51, the dough undergone fermentation is placed in a baking environment. That is, the control device 80 supplies the heating device 41 with power necessary for baking bread, and thereby raises the temperature of the baking chamber 40 into a bread-baking temperature range.

In step #52, the control device 80 checks how long the dough has been placed in the baking environment. When a predetermined time is found to have elapsed, the baking process #50 is finished. Here, completion of the bread making is announced in the form of a sign displayed on the display portion 22 or in sound, and in response to the announcement, the user opens the lid 30 and takes out the bread container 50. Then, the user takes the bread out of the bread container 50.

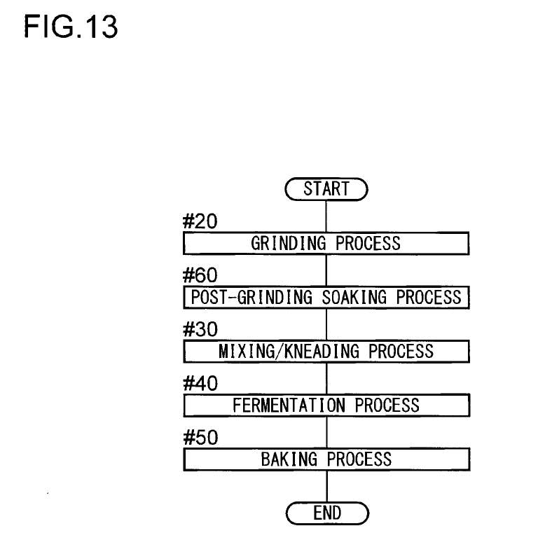

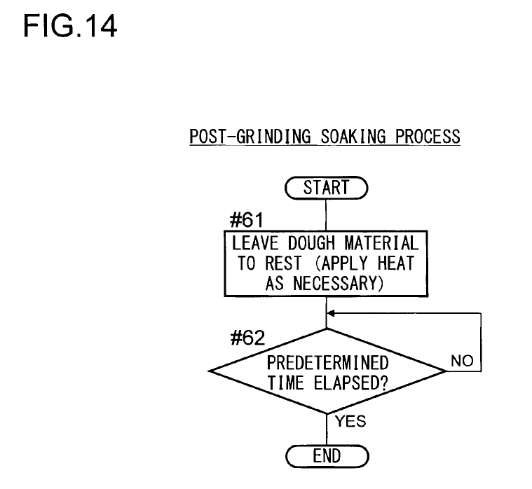

Next, a second example of bread making process will be described with reference to FIG. 13 and FIG. 14. FIG. 13 is an overall flow chart showing the second example of bread making process. As shown in FIG. 13, in the second example of bread making process, a grinding process #20, a post-grinding soaking process #60, a mixing/kneading process #30, a fermentation process #40, and a baking process #50 proceed in this order. Now, steps in the post-grinding soaking process #60 will be described based on FIG. 14.

In step #61, dough material formed in the grinding process #20 is left to rest in the bread container 50. The dough material here has not undergone the pre-grinding soaking process. While the dough material is left to rest, the liquid soaks into the ground cereal grains. The control device 80 energizes the heating device 41 as necessary to apply heat to the dough material to promote the soaking.

In step #62, the control device 80 checks how long the dough material has been left to rest. When a predetermined time is found to have elapsed, the post-grinding soaking process #60 is finished. When the post-grinding soaking process #60 is finished, the procedure automatically proceeds to the mixing/kneading process #30. The mixing/kneading process #30 and processes performed thereafter are the same as in the first example of bread making process.

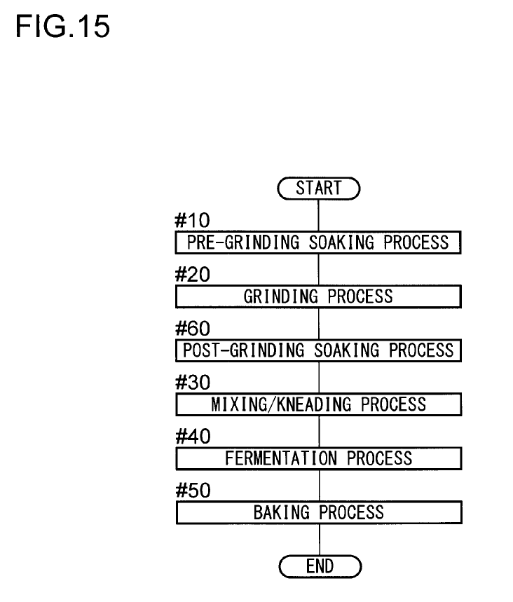

Next, a third example of bread making process will be described based on FIG. 15. FIG. 15 is an overall flow chart showing the third example of bread making process. Here, the pre-grinding soaking process #10 of the first example is carried out before a grinding process #20, and the post-grinding soaking process 60 of the second example is performed after the grinding process #20. A mixing/kneading process 30 and processes performed thereafter are the same as in the first example of bread making process.

The grinding blade 54 of the automatic bread making machine 1 of the first embodiment is able to be used not only to grind cereal grains but also to break optional ingredients such as nuts and leaf vegetables into small pieces. This makes it possible to bake bread containing a small-particle optional ingredient. The grinding blade 54 can also be used, for example, to grind foodstuff other than optional ingredients for bread or to grind crude drug materials.

In this embodiment, the single control device 80 is able to control the grinding blade 54 and the mixing/kneading blade 72 to rotate in association with each other, and thus, it is possible to impart rotation to the grinding blade 54 and the mixing/kneading blade 72 according to the kind and the amount of cereal grains in the stage of grinding cereal grains and in the stage of mixing/kneading the cereal flour resulting from the grinding, to thereby improve the quality of bread.

### Second Embodiment

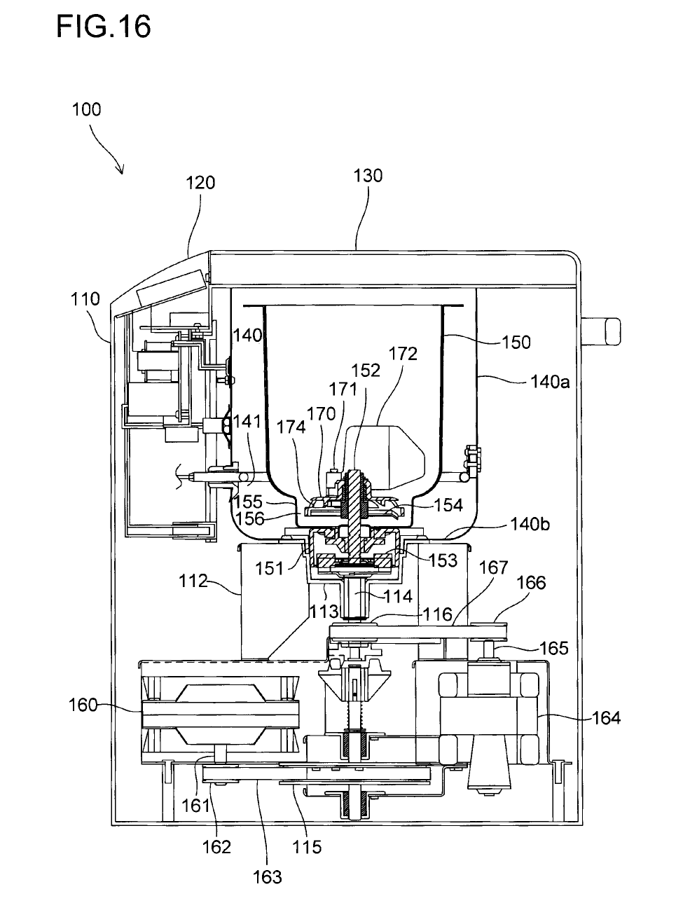

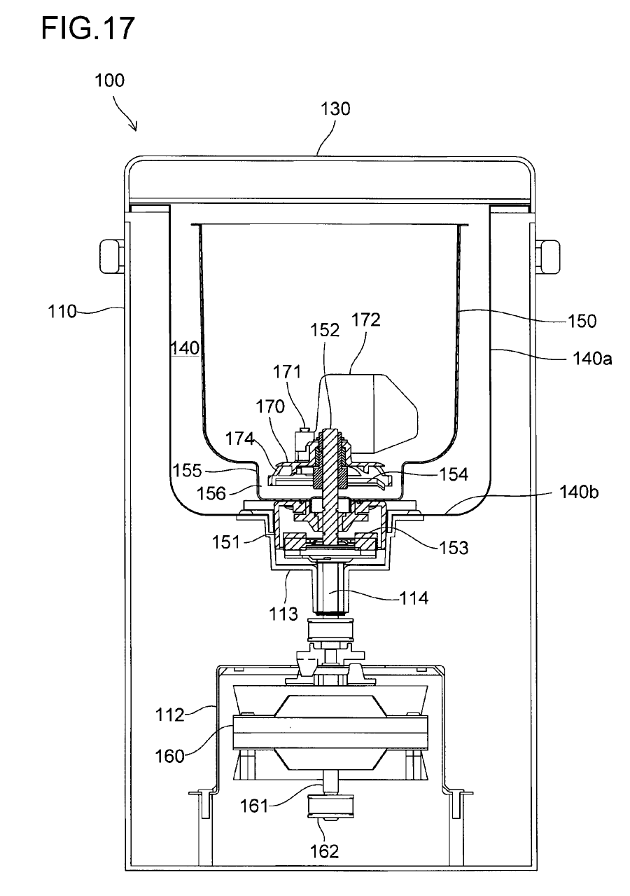

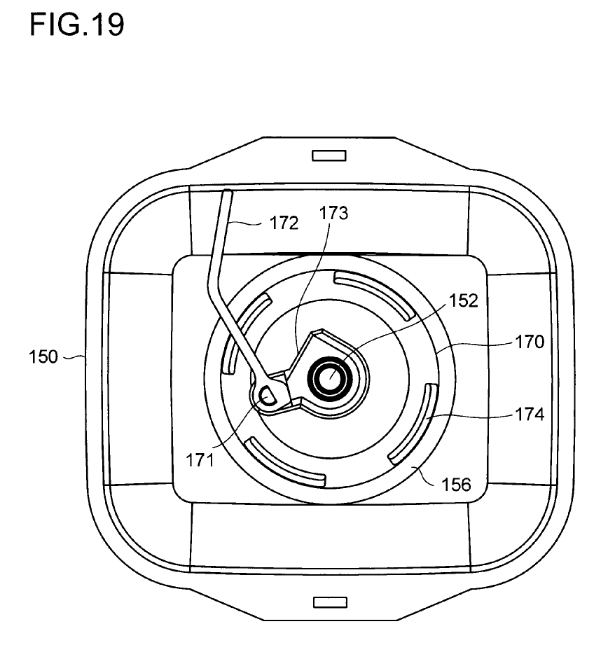

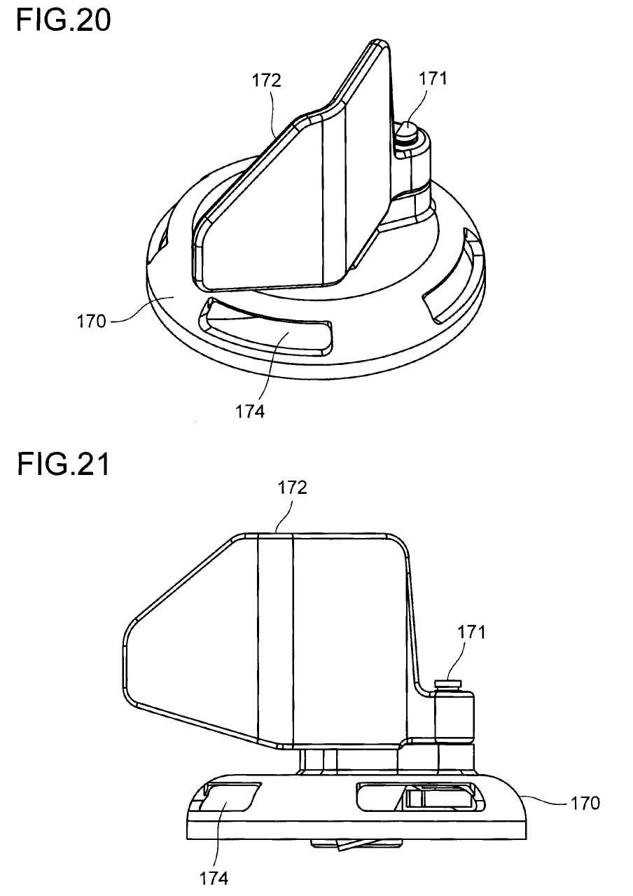

Next, the structure of an automatic bread making machine of a second embodiment will be described with reference to FIGS. 16 to 25. In FIG. 16, the left side is the front (façade) side of the automatic bread making machine 100, and the right side is the rear (back) side of the automatic bread making machine 100. The left-hand side and the right-hand side of an observer facing the front of the automatic bread making machine 100 are the left side and the right side, respectively, of the automatic bread making machine 100.

The automatic bread making machine 100 has a box-shaped body 110 formed with an external shell made of a synthetic resin. An operation portion 120 is provided in an upper front portion of the body 110. Although not illustrated in the figures, the operation portion 120 is provided with: a group of operation keys such as a key for selecting the type of bread (wheat bread, rice bread, bread with an optional ingredient, etc.) a timer key, a start key, and a cancellation key; and a display portion that displays a description of a set cooking program and time set through the timer key. The display portion is formed with a liquid crystal display panel and a display lamp including a light emitting diode as its light source.

A portion of the upper surface of the body behind the operation portion 120 is covered with a lid 130 made of a synthetic resin. The lid 130 is hinged to a rear edge of the body 110 with an unillustrated hinge shaft, to be swingable around the hinge shaft within a vertical plane.

Inside the body 110, a baking chamber 140 is provided. The baking chamber 140 is made of a sheet metal and has an open top through which a bread container 150 is put thereinto. The baking chamber 140 has a peripheral side wall 140a which is rectangular in horizontal section and a bottom wall 140b.

Inside the body 110, a base 112 made of a sheet metal is placed. On the base 112, there is fixed a bread container support portion 113 at a position corresponding to a position in the center of the baking chamber 40. The bread container support portion 113 is made by die casting an aluminum alloy. The inside of the bread container support portion 113 is exposed to the inside of the baking chamber 140.

At a position in the center of the bread container support portion 113, a drive shaft 114 is vertically supported. It is pulleys 115, 116 that impart rotation to the drive shaft 114. Clutches are arranged one between the pulley 115 and the drive shaft 114 and one between the pulley 116 and the drive shaft 114 such that, when the pulley 115 is made to rotate in a direction to transmit the rotation to the drive shaft 114, the rotation of the drive shaft 114 is not transmitted to the pulley 116, while, when the pulley 116 is made to rotate in a direction opposite to the direction in which the pulley 115 is made to rotate, to transmit the rotation to the drive shaft 114, the rotation of the drive shaft 114 is not transmitted to the pulley 115.

The pulley 115 is made to rotate by a mixing/kneading motor 160 supported by the base 112. The mixing/kneading motor 160 has a vertical shaft, and has an output shaft 161 protruding from a lower surface thereof. To the output shaft 161, there is fixed a pulley 162, which is coupled to the pulley 115 via a belt 163. The mixing/kneading motor 160 itself is a low-speed high-torque motor, and moreover, the pulley 162 makes the pulley 115 rotate at a reduced speed, and thus the drive shaft 114 rotates at a low speed and with a high torque.

The pulley 116 is made to rotate by a grinding motor 164 which is also supported by the base 112. The grinding motor 164 also has a vertical shaft, and has an output shaft 165 protruding from an upper surface thereof. To the output shaft 165, there is fixed a pulley 166, which is coupled to the pulley 116 via a belt 167.

The grinding motor 164 undertakes a role of imparting high-speed rotation to a later-described grinding blade. Thus, a high-speed rotation motor is chosen as the grinding motor 164, and the speed reduction ratio between the pulley 166 and the pulley 116 is set to approximately 1:1.

The bread container support portion 113 receives a cylindrical pedestal 151 which is fixed to a bottom surface of the bread container 150, and thereby supports the bread container 150. The pedestal 151 is also made by die casting an aluminum alloy.

The bread container 150 is made of a metal sheet in a form like a bucket, with a handle for carrying (not shown) attached to a rim of an opening thereof. The bread container 150 is rectangular with rounded corners in horizontal section. At a position in the center of a bottom portion of the bread container 150, a vertical blade rotation shaft 152 is vertically supported, with sealing applied thereto. To the blade rotation shaft 152, a rotational force is transmitted from the drive shaft 114 via a coupling 153. The coupling 153 is formed of two members, one of which is fixed to a lower end of the blade rotation shaft 152 and the other of which is fixed to an upper end of the drive shaft 114. The entirety of the coupling 153 is enclosed by the pedestal 151 and the bread container support portion 113.

Unillustrated protrusions are formed on an internal peripheral surface of the bread container support portion 113 and on an outer peripheral surface of the pedestal 151. These protrusions form a known bayonet coupling. Specifically, in attaching the bread container 150 to the bread container support portion 113, the bread container 150 is brought down such that the protrusions of the pedestal 151 do not interfere with the protrusions of the bread container support portion 113. Then, after the pedestal 151 is fitted into the bread container support portion 113, the bread container 150 is horizontally turned, so that the protrusions of the pedestal 151 are engaged under the protrusions of the bread container support portion 113, as a result of which the bread container 150 is fixed such that it cannot be pulled out upward. This operation also accomplishes coupling of the coupling 153. The bread container 150 is twisted, when being set, in the same direction as the rotation direction of a mixing/kneading blade which will be described later, such that rotation of the mixing/kneading blade does not cause the bread container 150 to come off.

A heating device 141 placed inside the baking chamber 140 surrounds the bread container 150 and applies heat to bread ingredients. The heating device 141 is formed with a sheath heater.

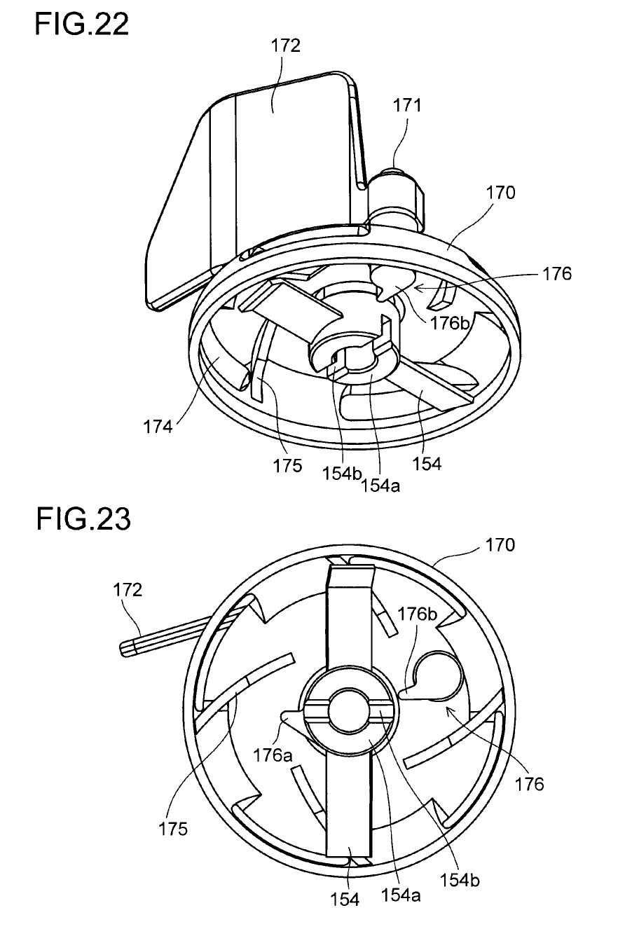

The blade rotation shaft 152 has a grinding blade 154 attached thereto at a position thereof slightly above the bottom portion of the bread container 150. The grinding blade 154 is unrotatable around the blade rotation shaft 152. The grinding blade 154 is made of stainless steel, and as shown in FIGS. 22 and 23, shaped like a propeller of an airplane.

A center portion of the grinding blade 154 is formed as a hub 154a that is fitted to the blade rotation shaft 152. In a lower surface of the hub 154a, a groove 154b is formed across the hub 154a in a diameter direction thereof. An unillustrated pin horizontally penetrating the blade rotation shaft 152 receives the hub 154a and engages with the groove 154b to unrotatably couple the grinding blade 154 to the blade rotation shaft 152. The grinding blade 154 is able to be easily pulled out of the blade rotation shaft 152, and this facilitates cleaning after a bread making operation and replacement of a dull grinding blade 154 with a new one.

To an upper end of the blade rotation shaft 152, a dome-shaped cover 170 having a circular shape in plan view is attached. The cover 170 is made by die casting an aluminum alloy, and covers up the grinding blade 154. The cover 170 is rotatably fitted to the blade rotation shaft 152, and is received by the hub 154a of the grinding blade 154. The cover 170 is also able to be easily pulled out of the blade rotation shaft 152, and this facilitates cleaning after a bread making operation.

A mixing/kneading blade 172 having a “<” shape in plan view is attached to an external surface of the cover 170 via a vertical support shaft 171 arranged at a place away from the blade rotation shaft 152. The mixing/kneading blade 172 is also made by die casting an aluminum alloy. The support shaft 171 is fixed to or integrally formed with the mixing/kneading blade 172, and moves with the mixing/kneading blade 172.

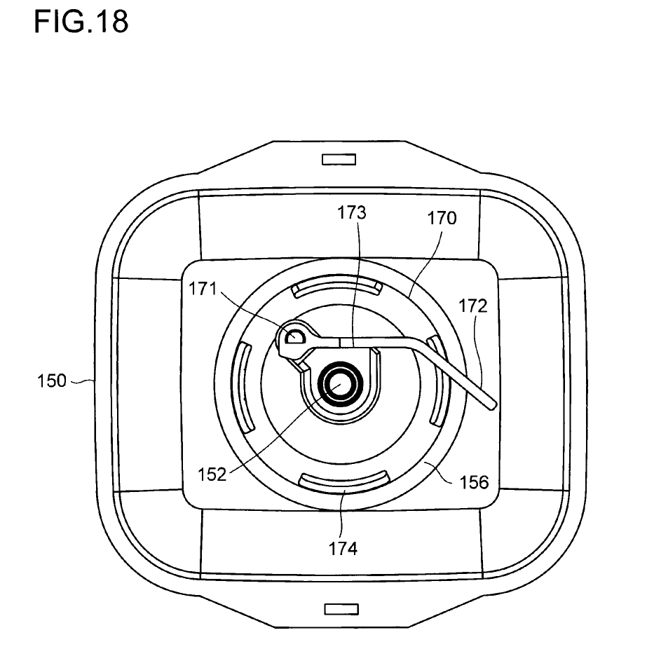

The mixing/kneading blade 172 rotates around the support shaft 171 in a horizontal plane with respect to the cover 170, and takes two postures, namely, a folded posture shown in FIG. 18 and an open posture shown in FIG. 19. In the folded posture, the mixing/kneading blade 172 is in contact with a stopper portion 173 formed in the cover 170, so that the mixing/kneading blade 172 is prevented from further rotating clockwise with respect to the cover 170. At this time, a tip end of the mixing/kneading blade 172 slightly protrudes from the cover 170. In the open posture, the mixing/kneading blade 172 is away from the stopper portion 173, and the tip end of the mixing/kneading blade 172 much protrudes from the cover 170.

In the cover 170, there is formed a window 174 through which a space inside the cover and a space outside the cover communicate with each other. The window 174 is located at the same height as, or higher than, the grinding blade 153. In this embodiment, four windows are formed as the window 174 to be arranged at intervals of 90°, but any number of windows may be arranged at any intervals.

As shown in FIGS. 22 and 23, on an internal surface of the cover 170, a total of four ribs 175 are formed corresponding to the windows 174 on a one-to-one basis. Each of the ribs 175 extends obliquely with respect to a radius direction of the cover 170 from near a center of the cover 170 to a circumferential annular wall of the cover 170, the four ribs 175 being arranged in a kind of tomoe-formation (a formation that looks like a fan impeller). Furthermore, the ribs 175 are each curved such that a side thereof which faces the bread ingredients rushing thereto is convex. The grinding blade 154 rotates so close to lower edges of the ribs 175 that the grinding blade 154 almost shaves the lower edges of the ribs 175.

A clutch 176 (see FIG. 23) is provided between the cover 170 and the blade rotation shaft 152. The clutch 176 couples the cover 170 to the blade rotation shaft 152 in a direction in which the blade rotation shaft 152 rotates when the mixing/kneading motor 160 makes the drive shaft 114 rotate (hereinafter, rotation in this direction will be referred to as “forward rotation”). On the other hand, in a direction in which the blade rotation shaft 152 rotates when the grinding motor 164 makes the drive shaft 114 rotate (hereinafter, rotation in this direction will be referred to as “backward rotation”), the clutch 176 uncouples the cover 170 from the blade rotation shaft 152. Incidentally, in FIGS. 18 and 19, the “forward rotation” is a counterclockwise rotation and the “backward rotation” is a clockwise rotation.

The clutch 176 is composed of a first engagement body 176a and a second engagement body 176b. The first engagement body 176 is fixed to or integrally formed with the hub 154a of the grinding blade 154, and thus is unrotatably attached to the blade rotation shaft 152. The second engagement body 176b is fixed to or integrally formed with the support shaft 171 of the mixing/kneading blade 172, and changes its angle as the mixing/kneading blade 172 changes its posture.

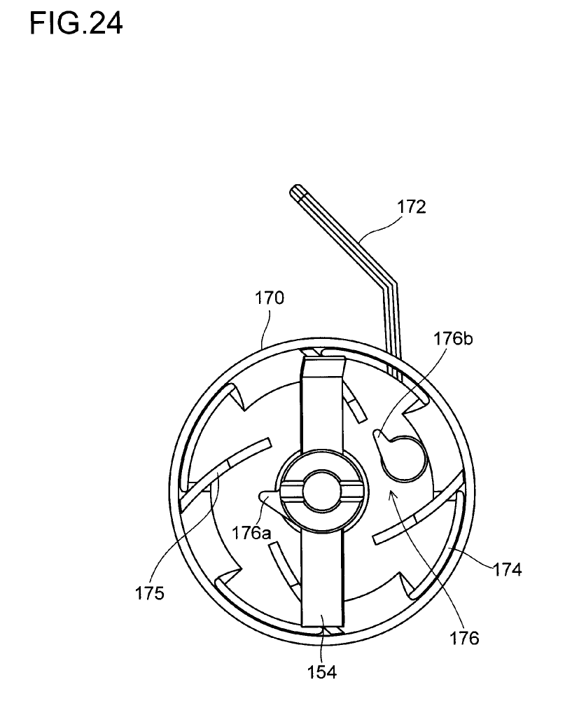

The clutch 176 changes its coupling state according to the posture of the mixing/kneading blade 172. Specifically, when the mixing/kneading blade 172 is in the folded posture as shown in FIG. 18, the second engagement body 176b is at the angle shown in FIG. 23. In this state, the second engagement body 176b interferes with the rotation path of the first engagement body 176a; when the blade rotation shaft 152 rotates clockwise in FIG. 23, in other words, rotates forward, the first engagement body 176a engages with the second engagement body 176b, and the rotational force of the blade rotation shaft 152 is transmitted to the cover 170 and the mixing/kneading blade 172. When the mixing/kneading blade 172 is in the open posture as shown in FIG. 19, the second engagement body 176b is at an angle shown in FIG. 24. In this state, the second engagement body 176b is withdrawn from the rotation path of the first engagement body 176a; when the blade rotation shaft 152 rotates counterclockwise in FIG. 24, in other words, rotates backward, no engagement occurs between the first engagement body 176a and the second engagement body 176b. Thus, the rotational force of the blade rotation shaft 152 is not transmitted to the cover 170 and the mixing/kneading blade 172.

In a bottom portion of the bread container 150, a recess 155 is formed to accommodate the grinding blade 154 and the cover 170. The recess 155 is circular in plan view, and between an outer peripheral portion of the cover 170 and an internal surface of the recess 155, there is provided a clearance 156 that allows passage of the bread ingredients therethrough.

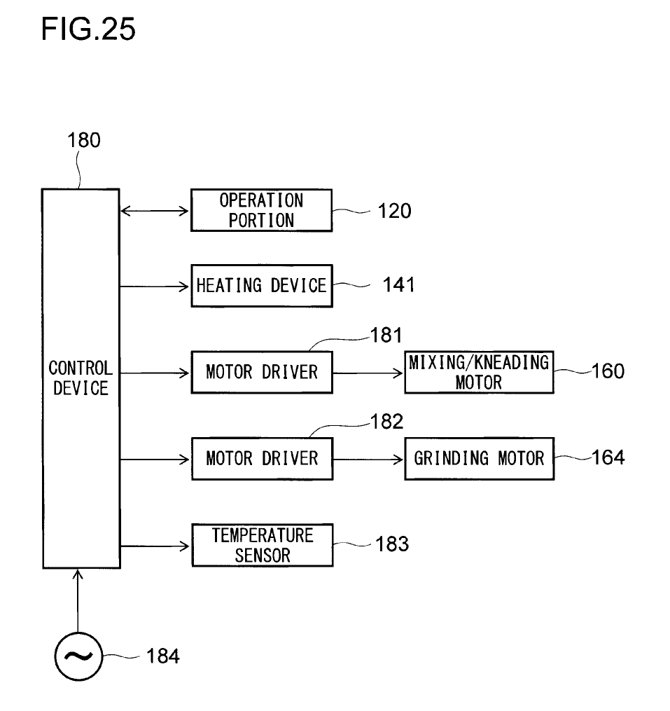

Operation of the automatic bread making machine 100 is controlled by a control device 180 shown in FIG. 25. The control device 180 is formed of a circuit board appropriately located within the body 110 (preferably, at a place where it is least affected by heat from the baking chamber 140). To the control device 180, the operation portion 120 and the heating device 141 are connected, and further, a motor driver 181 of the mixing/kneading motor 160, a motor driver 182 of the grinding motor 164, and a temperature sensor 183 are also connected to the control device 180. The temperature sensor 183 is disposed inside the baking chamber 140, and detects temperature of the baking chamber 140. Reference numeral 184 denotes a commercial power supply that supplies power to each component.

Next, a description will be given of a process of making bread from cereal grains by using the automatic bread making machine 100. Here, the process of making bread from cereal grains by using the automatic bread making machine 100 of the second embodiment is basically the same as the process (shown in FIGS. 7 to 15) of making bread from cereal grains by using the automatic bread making machine 1 of the first embodiment. Thus, the description will be focused on differences resulting from the difference in structure between the automatic bread making machine 100 of the second embodiment and the automatic bread making machine 1 of the first embodiment, and overlapping descriptions will be omitted.

The automatic bread making machine 100 of the second embodiment operates differently from the automatic bread making machine 1 of the first embodiment in the grinding process shown in FIG. 9 and the mixing/kneading process shown in FIG. 10, and the differences will be described below. First, a description will be given of the grinding process shown in FIG. 9, which is carried out soon after the pre-grinding soaking process #10. When a user inputs grinding operation data (kind and amount of the cereal grains, kind of bread to be baked, etc.) through the operation portion 120 and presses the start key, step #21 is started.

In step #21, the control device 180 drives the grinding motor 164, to make the blade rotation shaft 152 rotate backward. Then, the grinding blade 154 starts rotating in the mixture of cereal grains and liquid. The cover 170 also follows the blade rotation shaft 152 to rotate. The direction in which the cover 170 rotates at this time is clockwise in FIG. 18, and the mixing/kneading blade 172, when it is in the folded posture, moves into the open posture on receiving resistance from the mixture of the cereal grains and the liquid. When the mixing/kneading blade 172 moves into the open posture, the clutch 176 uncouples the cover 170 from the blade rotation shaft 152 by withdrawing the second engagement body 176b from the rotation path of the first engagement body 176a. At the same time, the mixing/kneading blade 170 in the open posture hits an internal wall of the bread container 150 as shown in FIG. 19 to prevent rotation of the cover 170. Thereafter, the blade rotation shaft 152 and the grinding blade 154 rotate backward at high speed. Even though the grinding blade 154 is rotating at high speed, since the cover 170 and the mixing/kneading blade 172 are not moving, the mixture of the cereal grains and the liquid does not swirl in the bread container 150. This helps prevent occurrence of a situation in which a swirl rises along the periphery of the bread container 150 to flow over the bread container 150.

While the cover 170 is not rotating, the grinding blade 154 rotates at high speed to grind the cereal grains. Since the cereal grains are ground by the grinding blade 154 in a state in which the liquid has soaked thereinto, the cereal grains are easily ground to their cores. The ribs 175 each extending from near the center of the cover 170 to the circumferential annular wall of the cover 170 assist the grinding by reducing the flow of the mixture of the cereal grains and the liquid in the same direction as the rotation direction of the grinding blade 154. That is, the ribs 175 change the flow of the mixture to increase the chances for the mixture to hit against the grinding blade 154. Since the grinding is performed inside the cover 170, the cereal grains are prevented from scattering outside the bread container 150.

The mixture of the ground cereal grains and the liquid is guided by the ribs 175 toward the windows 174, through which the mixture is discharged out of the cover 170. Also, since each of the ribs 175 is curved to protrude on the side thereof which faces the mixture of the cereal grains and the liquid rushing thereto, the mixture of the cereal grains and the liquid is less likely to stay on the surface of each of the ribs 175 and more likely to flow smoothly toward the windows 174.

When the mixture of the cereal grains and the liquid is discharged from inside the cover 170, the mixture of the cereal grains and the liquid present above the recess 155 moves into the recess 155 through the clearance 156 and then moves from the recess 155 into the cover 170. The cereal grains are ground by the grinding blade 154 inside the cover 170, and return to above the recess 155 through the windows 174 of the cover 170. By grinding the cereal grains while making them circulate in this way, it is possible to efficiently grind the cereal grains. The provision of the ribs 175 allows the ground substance produced by the grinding blade 154 to be quickly guided to the windows 174 without remaining in the cover 170, and this further improves the grinding efficiency.

Since the windows 174 are located at the same height as or higher than the grinding blade 153, the mixture of the ground cereal grains and the liquid is discharged out of the cover 170 in a horizontal or obliquely upward direction, and this helps promote the circulation of the cereal grains.

In step #22, the control device 180 checks whether or not the grinding has been completed according to a set grinding pattern (whether the grinding blade is to be continuously rotated or intermittently rotated interspersed with stop periods, how the intervals be set and how long a rotation time period should be in the case of intermittent rotation, etc.).

When the grinding is found to have been completed according to the set grinding pattern, the procedure proceeds to step #23, where the grinding blade 154 is made to stop rotating, and the grinding process #20 is finished. This is informed to the user through a display provided on the display portion 122, through sound, etc.

Following the grinding process #20, the mixing/kneading process #30 shown in FIG. 10 is carried out. At the start of the mixing/kneading process #30, the cereal grains and the liquid in the bread container 150 have become a dough material in a pasty or slurry state.

In step #31, the user opens the lid 130 to add a certain amount of gluten to the dough material. A seasoning such as salt, sugar, or shortening is added to the dough material as necessary. It is also possible to provide the automatic bread making machine 100 with an automatic feeder for gluten and seasoning to throw them in without bothering the user.

Substantially simultaneously with step #31, the user operates the operation portion 120 to input the kind of bread to be baked and the cooking program to be performed. When the machine is ready, the user presses the start key, to start the bread making operation in which processes are automatically performed in series from the mixing/kneading process #30, to the fermentation process #40, and to the baking process #50.

In step #32, the control device 180 drives the mixing/kneading motor 160. When the blade rotation shaft 152 rotates forward to cause the cover 170 to rotate forward, the mixing/kneading blade 172 receives resistance from the dough material to convert a posture thereof from the open posture into the folded posture. In response to this, in the clutch 176, the second engagement body 176b moves to be at such an angle as to interfere with the rotation path of the first engagement body 176a, and thereby the clutch 176 couples the cover 170 to the blade rotation shaft 152, so that the cover 170 and the mixing/kneading blade 172 together rotate integrally with the blade rotation shaft 152.

Here, the control device 180 energizes the heating device 141 to raise the temperature of the baking chamber 140. The mixing/kneading blade 172 rotates to mix/knead the dough material, which is thereby worked into a lump of dough having predetermined elasticity. The mixing/kneading blade 172 swings the dough around and beats it against an internal wall of the bread container 150, and this adds an element of “kneading” to the mixing/kneading process.

When the cover 170 rotates, the ribs 175 rotate as well. As the ribs 175 rotate, the dough material inside the cover 170 is quickly discharged through the windows 174, to mix with the lump of dough material mixed and kneaded by the mixing/kneading blade 172.

In step #33, the control device 180 checks how much time has elapsed since the start of the rotation of the mixing/kneading blade 172. When a predetermined period of time is found to have elapsed, the procedure proceeds to step #34.

In step #34, the user opens the lid 130 to add yeast to the dough. The yeast added to the dough here is dry yeast. Instead of yeast, baking powder may be used. It is also possible to adopt an automatic feeder for yeast or baking powder as well, to thereby save the user time and trouble.

In step #35, the control device 180 checks how much time has elapsed since the addition of yeast to the dough. When a period of time necessary to obtain desired dough is found to have elapsed, the procedure proceeds to step #36, where the mixing/kneading blade 172 finishes rotating. At this time, a lump of dough having required elasticity is completed. Most part of the dough stays above the recess 155, and only a very small part thereof is left in the recess 155. In the case of baking bread with an optional ingredient, at any step in the mixing/kneading process #30, the optional ingredient is added. An automatic feeder can be adopted for optional ingredients as well.

Thereafter, in the same manner as with the automatic bread making machine 1 of the first embodiment, the fermentation process #40 (see FIG. 11) and the baking process (see FIG. 12) are carried out to bake bread. Here, a trace of the mixing/kneading blade 172 is left in the bottom of resulting bread when it is taken out of the bread container 150; however, as to the cover 170, since it is accommodated in the recess 155 and thus does not protrude from the bottom portion of the bread container 150, it does not leave a large trace in the bottom of the resulting bread.

In the same manner as with the automatic bread making machine 1 of the first embodiment, the grinding blade 154 of the automatic bread making machine 100 of the second embodiment is able to be used not only to grind cereal grains but also to break optional ingredients such as nuts and leaf vegetables into small pieces. This makes it possible to bake bread containing a small-particle optional ingredient. The grinding blade 154 can also be used, for example, to grind foodstuff other than optional ingredients for bread or to grind crude drug materials.

In this embodiment as well, the single control device 180 is able to control the grinding blade 154 and the mixing/kneading blade 172 to rotate in association with each other, and thus, it is possible to impart rotation to the grinding blade 154 and the mixing/kneading blade 172 according to the kind and the amount of the cereal grains in the stage of grinding cereal grains and in the stage of mixing the cereal flour resulting from the grinding, to improve the quality of bread.

(Others)

It should be understood that the first and second embodiments of automatic bread making machines specifically described above are not meant to limit the present invention, and that the present invention can be practiced with many modifications within the spirit of the present invention.

### INDUSTRIAL APPLICABILITY

The present invention is widely applicable to automatic bread making machines for use mainly in general households.

### LIST OF REFERENCE SYMBOLS

1, 100 automatic bread making machine
10, 110 body
40, 140 baking chamber
50, 150 bread container
52, 152 blade rotation shaft
54, 154 grinding blade
60 motor
70, 170 cover
72, 172 mixing/kneading blade
160 mixing/kneading motor
164 grinding motor
174 window
175 rib
176 clutch

1. An automatic bread making machine, comprising:
a bread container in which a bread ingredient is put;
a baking chamber which is provided inside a body and accommodates the bread container;
a blade rotation shaft which is provided at a bottom portion of the bread container;
a grinding blade and a mixing/kneading blade which are rotatable by rotation of the blade rotation shaft; and
a motor which is provided inside the body and imparts a rotational force to the blade rotation shaft,
wherein
a grinding function is exerted by using the grinding blade when the blade rotation shaft rotates in one direction, while a mixing/kneading function is exerted by using the mixing/kneading blade when the blade rotation shaft rotates in a direction opposite to said one direction.

2. The automatic bread making machine of claim 1,
wherein
the grinding blade is unrotatably attached to the blade rotation shaft;
the mixing/kneading blade is provided on an external surface of a dome-shaped cover which is attached to the blade rotation shaft so as to cover the grinding blade; and
a rotational force of the blade rotation shaft is not transmitted to the cover when the blade rotation shaft rotates in said one direction, while the cover rotates together with the blade rotation shaft when the blade rotation shaft rotates in the direction opposite to said one direction.

3. The automatic bread making machine of claim 2, wherein the mixing/kneading blade is bonded to the external surface of the cover.

4. The automatic bread making machine of claim 2,
wherein
a clutch is provided between the blade rotation shaft and the cover; and
the clutch uncouples the blade rotation shaft and the cover from each other when the blade shaft rotates in said one direction, while the clutch couples the blade rotation shaft and the cover to each other when the blade rotation shaft rotates in the direction opposite to said one direction.

5. The automatic bread making machine of claim 4,
wherein
the mixing/kneading blade is attached to the cover such that a posture of the mixing/kneading blade is changeable; and
the clutch switches a state of coupling between the blade rotation shaft and the cover according to the posture of the mixing/kneading blade.

6. The automatic bread making machine of claim 2,
wherein
the cover has formed therein at least one window through which a space inside the cover and a space outside the cover communicate with each other; and
an internal surface of the cover has formed thereon at least one rib which guides a ground substance produced by the grinding blade toward the window.

7. The automatic bread making machine of claim 6, wherein the window is located at a same height as, or higher than, the grinding blade.

8. The automatic bread making machine of claim 6,
wherein
the rib extends obliquely with respect to a radius direction of the cover from near a center of the cover to a circumferential annular wall of the cover, the rib being curved such that a side thereof which faces bread ingredients when the bread ingredients rush thereto is convex.
